(19) United States
(12) Patent Application Publication
(10) Pub. No.: US 2023/0085003 A1
(43) Pub. Date: Mar. 16, 2023

(54) SYSTEM FOR REQUESTING AND PROVIDING AN IN-HOME SERVICE

(71) Applicant: Teodiknorik Markariansirak, La Crescenta, CA (US)

(72) Inventor: Teodiknorik Markariansirak, La Crescenta, CA (US)

(21) Appl. No.: 17/473,960

(22) Filed: Sep. 13, 2021

(51) Int. Cl. G06Q 10/10; G06Q 50/10

(52) U.S. Cl. CPC G06Q 10/1095; G06Q 50/10

(57) ABSTRACT

A system for requesting and providing an in-home service is disclosed, comprising a requester device to permit a requester to transmit a request for an in-home service to a provider device via a network. A service database stores service information corresponding to a plurality of services. A provider database stores provider information corresponding to a plurality of providers, wherein a search engine is operable to permit the request to search the provider information and select the in-home service via a user interface module.

### CROSS-REFERENCE TO RELATED APPLICATIONS

The present application claims priority to U.S. Provisional Application No. 63/050,892 filed Jul. 13, 2020, titled “SYSTEM FOR REQUESTING AND PROVIDING AN IN-HOME SERVICE,” which is hereby incorporated by reference in its entirety.

### TECHNICAL FIELD

The embodiments disclosed herein generally relate to computer implemented systems and methods for requesting and providing health and wellness and other personal services.

### BACKGROUND

Health and wellness services are often performed at a business location, such as an office, hotel, spa, or other location that requires customers to travel to the business location to experience the service. Unfortunately, traveling to a physical location may be uncomfortable or inconvenient for some customers who are unable to travel due to cost, injury, time constraints, accessibility, fear of contacting or interacting with large numbers of people in public, and other issues. Advances in computing systems have allowed many of these businesses offering health and wellness and other personal services to provide online scheduling systems for their brick-and-mortar businesses; however, few systems allow or provide for the scheduling of on-demand, in-home services in an organized and centralized manner.

In many cases, health and wellness services require the expertise of at least one trained professional, who may be trained in one or more of a variety of disciplines such as massage therapy, make-up artistry, hair styling, skin treatment, and others. Some of these various disciplines also require licenses and other formal documentation or recognition to legally practice or perform services. Unfortunately, no current systems exist to verify the credentials of in-home health and wellness service providers.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein relate to computer implemented systems and methods for requesting and providing in-home services. In general, these computer implemented systems and methods include a requester device that is functionally configured to permit a requester to transmit a request for an in-home service via a network to a provider device. In various implementations, servers are included and one or more service databases store service information corresponding to a plurality of offered services. Former, current, and future availability features can be provided to allow requesters to review previous service requests and schedule future service requests. One or more provider databases that are configured to store provider information corresponding to a plurality of providers are also provided. One or more search engines are operably configured and connected to permit the requester to search for provider information and select in-home services via a user interface module of the requester device.

The embodiments described herein provide computerized systems and methods for requesting in-home health and wellness and other services, which are often otherwise performed in a brick-and-mortar business. These in-home services can include, but are not limited to, massage therapy, skin care, hair care and maintenance, and similar wellness and beauty services. The embodiments described herein can also be adapted to a variety of other services that are also contemplated, including spiritual services, counseling services, physical therapy services, acupuncture services, teaching services, dental services, optometry services, fitness and athletic services, life coaching services, organizing services, coaching services, activity and event planning services, doula services, travel agent services, pet grooming services, cleaning services, self-defense instruction services, mechanic services, notary services, chef and cooking services, baking services, seamstress and tailor services, repair services, handyman services, writing services, inspection services, smogging services, tutoring services, power washing services, consulting services, investigation services, packing and unpacking services, carpet services, specialized staffing services, accounting services, tax services, computer services, driving services, translation services, catering services, training services, handyman services, installation services, pool services, lawn care services, painting services, sitting services, decorating services, entertainment services, new mother and infant services, photography services, and many others.

Requesters may utilize the visual display and audio output of a computing device to navigate a user interface. This can allow the requester to select a service type, scheduling information, pricing information, licensing and credential verification information, and others to allow the user to submit a request. Many embodiments allow for request customization to an even greater level. Once confirmed by the user, the system can then find and match providers who fulfill some or all of the various aspects of the request. Payment can be transmitted electronically using the requester device via the network to the provider at any time before, during, or following the service in various embodiments. The system can also provide incentives to the service provider by removing the need to pay costly fees for a brick-and-mortar business facility or space therein, while customer requesters benefit by receiving the service in the comfort of their own home.

In one aspect, a scheduling system provides a means for scheduling an in-home service via the requester device.

In one aspect, a GPS or other location determining system can determine and use a location for the requester and/or the provider, wherein the provider can input a maximum distance from the requester, the requester can input a maximum distance from the requester, or other distance features can be used.

In one aspect, a communications engine permits communication between the requester and the provider to discuss payment information, licensing and certification, services, customization, or any of a number of other issues, with preset questions and answers, freeform, and combinations thereof.

In one aspect, a payment processing engine permits the transmission of money or other medium of economic exchange between the requester and the provider in any number of forms, including standard currency, cryptocurrency, gift cards, and others.

In one aspect, service information comprises the following: service type, provider gender, service cost, length of service, location of service, age of provider, form of service, customizations or preferences, add-ons or bonuses, deals or sales, date and time of service, and others

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of the network infrastructure, according to some embodiments;

FIG. 2 illustrates a block diagram of the in-home service system, according to some embodiments;

FIG. 3 illustrates a block diagram of the scheduling system, according to some embodiments;

FIG. 4 shows a user interface screen, including a scheduling calendar and related features, according to various embodiments;

FIG. 5 shows a user interface screen, including mapping and related functionality, according to various embodiments;

FIG. 6 shows a user interface screen, including a service provider profile, according to various embodiments;

FIG. 7 shows a user interface screen, including a chat window between a service provider and requester, according to various embodiments; and

FIG. 8 shows a user interface screen, including certifications and background check information, according to various embodiments.

### DETAILED DESCRIPTION

Before describing example embodiments in detail, it is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, the term “user” may relate to any person interacting with the various features of the system provided herein. Users can be requestors (i.e., a customer requesting an in-home service) as well as providers (i.e., a provider of a service, health and wellness professional, or organization or entity to which health and wellness professional belongs that is providing the service).

In general, the systems and methods provided herein are computer implemented and include requesting in-home or other requester demanded or desired location specific services (generally referred to herein as in-home services) that are otherwise independent or removed from a fixed, physical, brick and mortar location operated by a service provider. These in-home services can include, but are not limited to massage therapy, skin care, hair care and maintenance, and similar wellness and beauty services. As stated elsewhere herein, a number of other types of services can also benefit from the teachings and embodiments described herein and are likewise contemplated.

Requesters may utilize the display and audio system of a computing device to navigate a user interface allowing a requester to select a service type, scheduling information, pricing information, and many other types of information to allow the user to submit a request. The system will then determine if there are any matching providers and may present one or more providers to the request. In some embodiments, requesters may submit posting requests for providers to contact them about. In some embodiments this can include a bidding system. Payment for services may be transmitted electronically from the requester to the provider at any time before, during, or following the service.

To provide security, the system may require proof of a background check by the service providers and/or the requesters to ensure vetting of each party and their agents so they will be safe during the processes of rendering the service. For example, service providers may be required to prove licensing, certification, identification, and/or other information before the system will approve their application to provide services and interact with requesters. In some embodiments, this type of information can be automatically available in a tab or party profile. In some embodiments, it may be available on demand or by request. In some embodiments, information may be required to be updated on a regular basis (e.g. weekly, monthly, quarterly, yearly, or otherwise). Failure to update such information can trigger a review process or may cause an account to be temporarily suspended in some embodiments. Parties may be required to pay for their own background information check or other information in some embodiments, while in other embodiments the other party may pay for the information. Some embodiments require users to communicate with system administrators regarding documentation, while others may be required to use public notaries or system approved parties to verify documentation. Some embodiments allow the system to directly link to governmental, association, or other authority bodies to verify information accuracy.

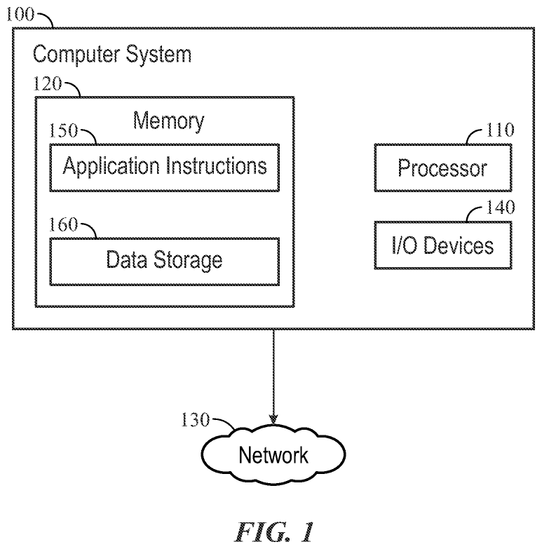

FIG. 1 illustrates a computer system 100, which can be utilized to provide and/or execute the processes described herein in various embodiments. The computer system 100 can be comprised of a standalone computer or mobile computing device, a mainframe computer system, a workstation, a network computer, a desktop computer, a laptop, a tablet, a smartphone, a videogame console, or the like. The computer system 100 includes one or more processors 110 coupled to a memory 120 via an input/output (I/O) interface. Computer system 100 may further include a network interface to communicate with the network 130. One or more input/output (I/O) devices 140, such as video device(s) (e.g., a camera), audio device(s), and display(s) are in operable communication with the computer system 100. In some embodiments, similar I/O devices 140 may be separate from computer system 100 and may interact with one or more nodes of the computer system 100 through a wired or wireless connection, such as over a network interface.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 100 and other devices attached to a network 130, such as other computer systems, or between nodes of the computer system 100. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

The memory 120 may include application instructions 150, configured to implement certain embodiments described herein, and a database 160, comprising various data accessible by the application instructions 150. In one embodiment, the application instructions 150 may include software elements corresponding to one or more of the various embodiments described herein. For example, application instructions 150 may be implemented in various embodiments using any desired programming language, scripting language, or combination of programming languages and/or scripting languages (e.g., C, C++, C#, JAVA®, JAVASCRIPT®, PERL®, etc.).

The steps and actions of the computer system 100 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

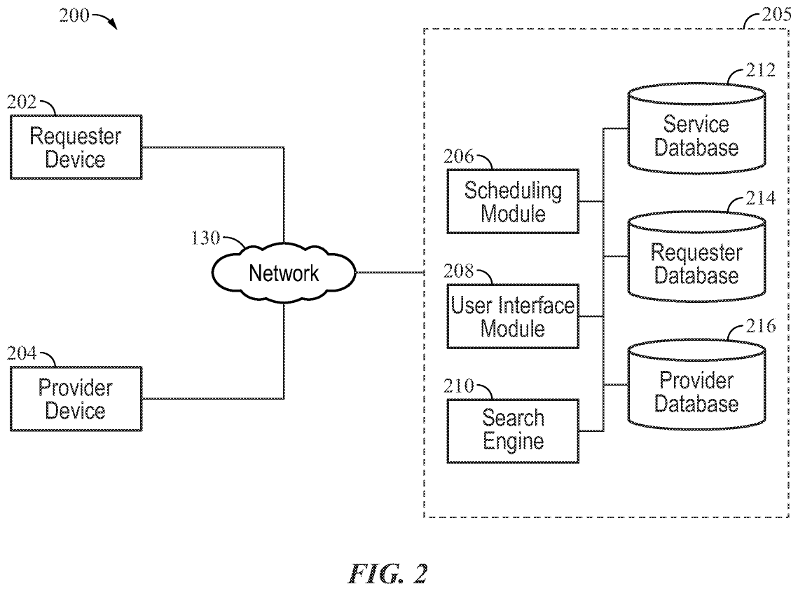

FIG. 2 illustrates a block diagram of the in-home service system 200 including a requester device 202 and a provider device 204 each interacting with the network 130. Users may operate the requestor device 202 to submit a request for the in-home service using an application system 205. In such, the user may select a service type, date and time they wish to have the service provided, a location, gender of the provider (if applicable), length of time of the service, special requests, and similar preferences known in the arts of scheduling the various forms of wellness services. The provider device 204 allows the provider to receive requests submitted by the requester and accept the request. Once accepted, the provider will receive information related to the request and will have the in-home service scheduled in a calendar system.

In further reference to FIG. 2, the application system 205 is in operable communication with a scheduling module 206, user interface module 208, search engine 210, service database 212, requester database 214, and provider database 216. The user interface module 208 provides information associated with the system onto the display of the computing device 202, 204. The scheduling module 206 receives scheduling information including availability for the requesters and providers, current scheduling information, and the like. This allows the system to automatically schedule a service once the request has been transmitted. The search engine 210 allows the user to search for services, service providers and organizations thereof, as well as allow for various search parameters to be input using the service database 212, requester database 214, and provider database 216.

In some embodiments, the service information may include the service type, length of the service (e.g., a 1-hour massage), cost of the service, gender of the service provider, experience of the service provider, licensing of the service provider, and location of the service (i.e., the requesters home location), and the like.

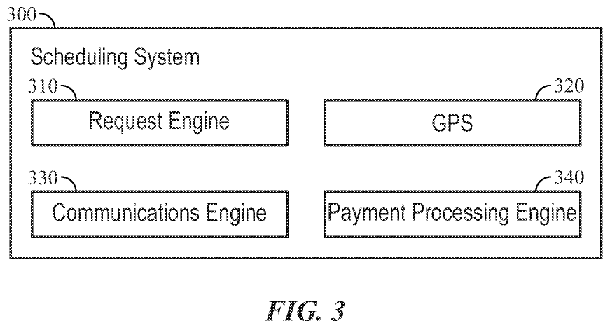

FIG. 3 illustrates a block diagram of the scheduling system 300 wherein a request engine 310 generates and transmits a request for a service based on user-defined parameters for the service. The GPS 320 determines a location of the requester and provider. A maximum distance may be established by the provider to only allow requests to be received from requestors within a pre-determined distance. A communications engine 330 may allow for communications to be made between the requestor and provider once a request has been submitted. For example, users may use the communications engine 330 to ask questions of the provider, confirm details of the request, confirm scheduling, and the like. A payment processing engine 340 provides a means for transmitting compensation between the requestor and provider. The payment processing engine 340 may utilize various payment algorithms to establish a fee for the service depending on availability of the provider, distance between the provider and requester, the length of the service provided, and the like.

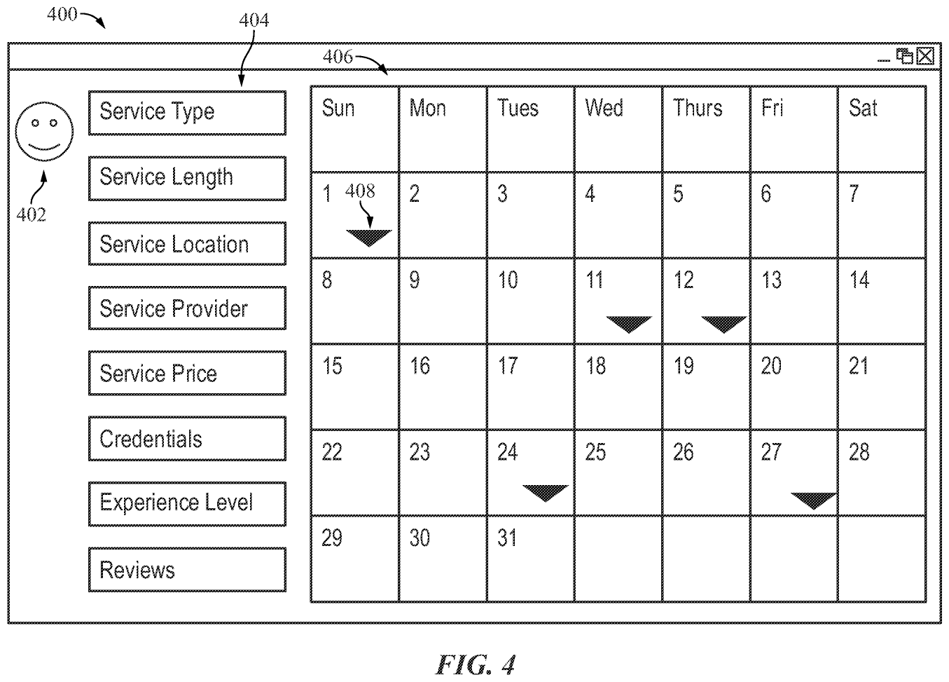

FIG. 4 shows a user interface screen 400, including a scheduling calendar and related features, according to various embodiments. As shown in the example embodiment, a user profile button 402 can allow a user to return to a user profile screen where a variety of information may be displayed and/or selectively hidden including a name, profile picture, additional pictures, banner, contact information including phone number, linked social media profile(s), address, email, or other information. A variety of interactive and selectable buttons, fields, and menus 404 can be provided in various embodiments. As applicable to this user interface screen and others shown and not shown, these can include radio buttons, data entry fields, drop down menus, auto-populating fields, pop out menus, scrollable bars, range setting windows, minimum and maximum fields, buttons, and others. Many different types of buttons, fields, and menus 404 can be provided that will cause the system to calculate and display different pertinent information. As shown, service type, service length, service location, service provider, service price, credentials, experience level, reviews, and other information can be used to narrow or broaden results. A calendar 406 can be displayed that may include days of the week, dates, times, and other scheduling information. Drop down or other buttons 408 can allow a user to view availability on certain days, schedule appointments, and/or request appointments.

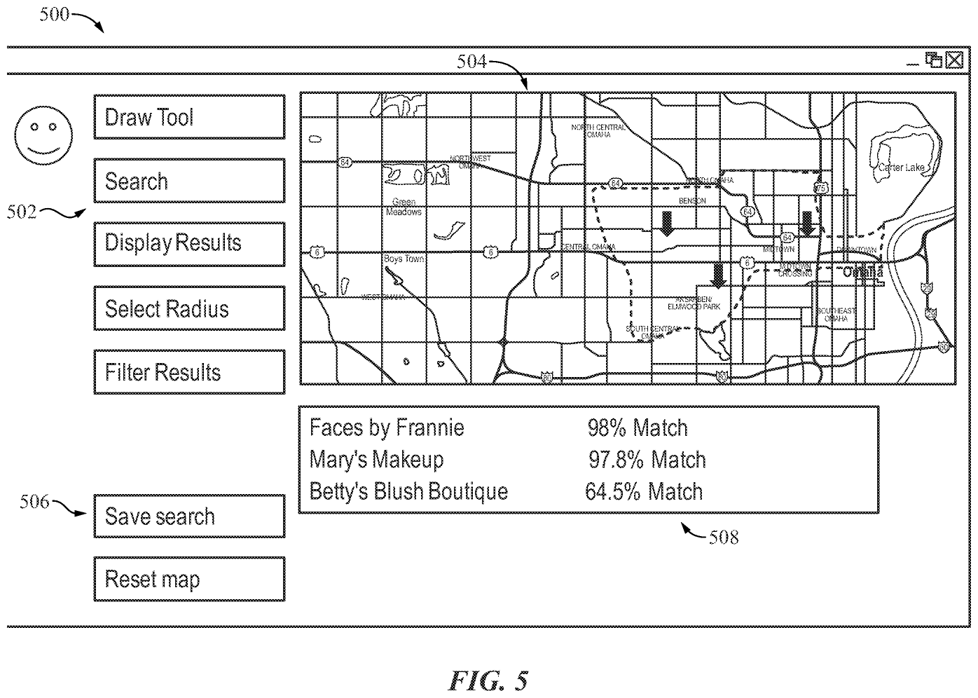

FIG. 5 shows a user interface screen 500, including mapping and related functionality, according to various embodiments. As shown in the example embodiment, various interactive buttons, fields, and menus 502 can be provided that allow a user to customize the area they would like to receive service. This can include drawing buttons and/or tools, whereby a user may encircle or lasso around particular neighborhoods on a map 504 that they wish to draw service provide pool names from. As such, certain neighborhoods and/or areas can be selectively chosen or omitted by users. Service provider names can also be entered into search fields. A radius around a particular location may be selected to create a pool within a certain geographic distance from where the user wishes to have their service performed. Results can be displayed and filtered accordingly by selecting appropriate buttons and/or using other appropriate tools. In some embodiments, post search buttons 506 can include a save search button that will allow a user to save the filters and search components they used in non-transitory memory in order to perform their geographic search again in the future and/or to remember what geographic search functions they have used in the past. A reset map button can be used by a user to remove the filters and search components they have included and to create a new search. A results window 508 can display a list, set of tabs, or other organized data field. As shown, matches may be provided with percentages, check marks, or other indicators showing how well each of the results matched the filters applied by the user.

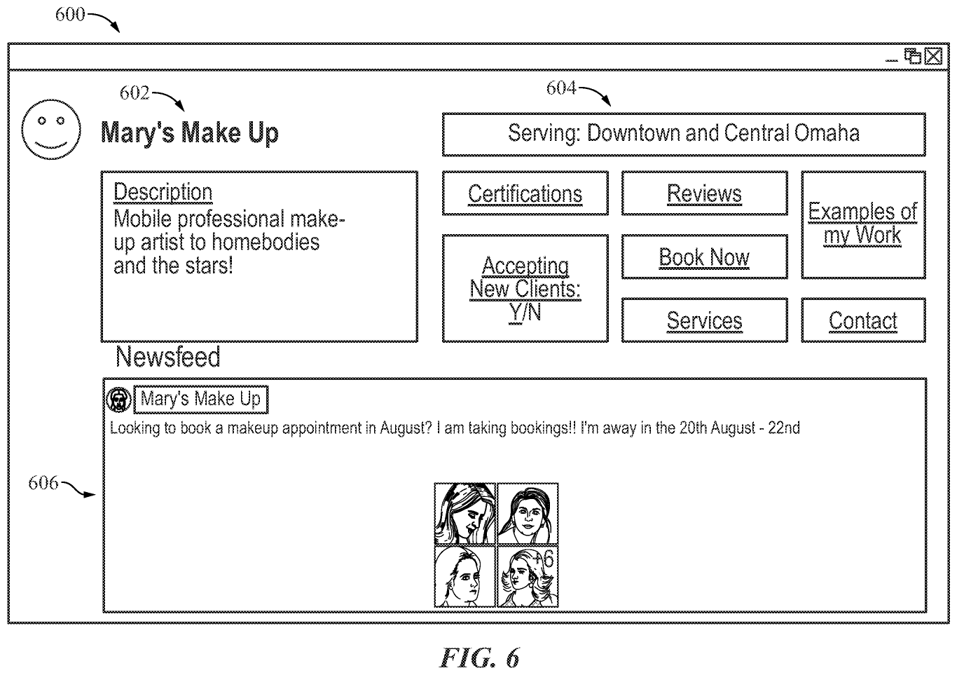

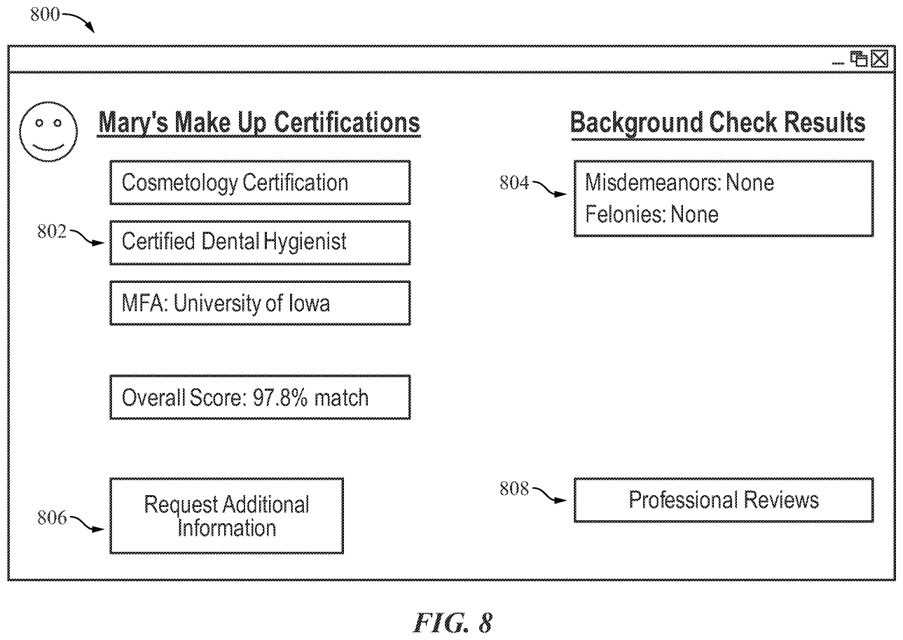

FIG. 6 shows a user interface screen 600, including a service provider profile, according to various embodiments. As shown in the example embodiment, a service provider profile can include identifying information 602, which can include a name and description as shown. Although not shown, it should be understood by those in the art that one or more profile pictures, banner pictures, videos, and other pertinent information can also be included. At least one additional information field and/or button 604 can also be included. As shown, these can include a description of where services may be ordered from and/or a geographic area where clients are serviced, a certification button or field that may display or take a user to a certification screen if selected (see, e.g. FIG. 8 and related description). An accepting new clients field may show an indication by color, letter, word, or other indication as to whether the service provider is allowing new clients to be added at the time the user is reviewing the profile. A review button can allow a user to view other user's reviews of the service provider's service(s). A book now button can take a user to a booking screen when selected by a user. This screen can include a calendar with dates and times or other means of booking appointments with the service provider. A services button or field may display or take a user to a listing or other manner of organized information as to what services the service provider is offering now, has offered in the past, and/or will be offering in the future. A service examples button or field may display sample pictures or videos of the service provider's work or ideas therefore, which can allow a user to examine or otherwise review the type(s) and quality of the work performed by the service provider. A contact button or field can allow a user to type a message or record a voice or video message that the service provider can review and then optionally respond to at their convenience. A newsfeed 606 can include one or more postings published by the service provider, “liked” by the service provider, and/or in which the service provider is tagged. In various embodiments the postings in a newsfeed can be interacted with by a user, who may select the postings to view in a larger window or screen, like, comment, or otherwise respond.

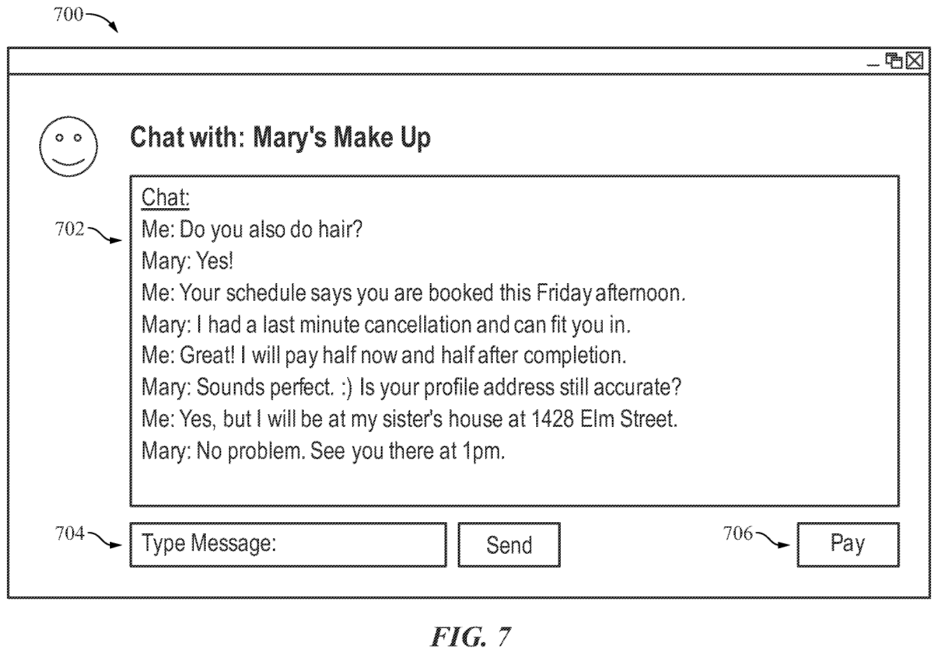

FIG. 7 shows a user interface screen 700, including a chat window between a service provider and requester, according to various embodiments. As shown in the example embodiment, a chat window 702 can include chat information between system users, particularly between service providers and service requesters. This can include questions about services, certifications, licenses, backgrounds, times, locations, and any other pertinent information. A message field 704 can allow a user to enter a text, image, and/or video message, whereby they can learn more information from the service provider. After a message has been composed it can be sent via the network to the other party by selecting the send button. A pay button 706 can allow a user to pay the service provider for their services. In various embodiments this can include scheduling payments, splitting payments into pieces or portions, paying using different types of currency, cryptocurrency, and/or gift cards, gifting services to other people, or otherwise. In some embodiments payment information can be saved in a secure database by the system for frequent and/or repeat or prospective repeat system users. Transactions may be disputed in some embodiments, and internal reviewing is also possible. Tips and add-ons are also contemplated.

FIG. 8 shows a user interface screen 800, including certifications and background check information, according to various embodiments. As shown in the example embodiment, a certifications portion 802 can include one or more certification information fields, which can include certificates, licenses, degrees, and/or other information about accreditation. A matching score can be provided that indicates a percent or amount of matching for a service provider based on a requester's selected filter criteria choices. Percentages can be calculated based on a number of matching criteria compared with a number of desired criteria, while other indicators can include check marks, colors (green, yellow, red, or otherwise), or others. A background check field area 804 can include background check information, including police reports, credit, or otherwise. Dates can be provided for information in this screen, indicating when it was last updated and/or verified and when or if updates are required or demanded again in the future. A request additional information field or button 806 can allow a requester to contact system administrator(s) and/or the service provider about any additional information the request is interested in learning more about. A professional reviews field or button 808 can display any reference or recommendation information from others in the field, including current and/or former coworkers, bosses, teachers, mentors, clients, and/or others who are familiar with the service provider's services.

It should be understood that in various embodiments thresholds can be used to determine if certain parameters are met. For example, a requester may include ten criteria that they would like a service provider to meet (e.g. available weekend afternoons, board certified, clean background, can provide service within four hours, etc.) and the system may check a database of providers and determine how many criteria one or more of the providers meet. If a certain threshold of the criteria are met (e.g. if seven or more out of ten are met), then the system can present the service provider as a “match” to the requester. In some embodiments, percentages can be display to the user, while in others a simple indication such as a check mark or thumbs up marker can indicate that the provider has met the minimum criteria. In some embodiments different criteria can have different weighting measures in calculations before comparing to criteria. For example, a clean background check may be a “make or break” or required criteria, while availability on a particular weekday may only have a minimal impact on a matching score.

Ranges can be an important part of matching algorithms in various embodiments. In some embodiments ranges can include geographical distance ranges, while in other embodiments, ranges may be numerical ranges between minimal and upper limits.

As should be understood by those in the art, many embodiments contemplate and even rely on connection to and integration with data from third party systems, including mapping databases, scheduling programs, conversation platforms, social media platforms, review sites. As such, parties can create profiles on other platforms that can then be linked with the system's databases in order to supplement details provided directly to the website and various other functions. For example, the system may not include its own proprietary mapping software in various embodiments but it may couple with third party mapping software in order to display maps and use such maps to calculate distances and/or display matches based on criteria. Likewise, conversation and/or social media platforms can be integrated with the system and/or granted cross-platform access. Similarly, calendar and scheduling platforms can be integrated and/or cross-referenced with the system platform in various embodiments.

Artificial intelligence (AI) and/or machine learning can be implemented in many embodiments and help improve, tailor, and/or train results over time. Example AI implementations can take into account and use punctuality, distance, reviews, repeat uses, updated background and certification information, and other information before making recommendations. As such, self reported and system integrated information and data measurements can be used to provide results to requesters that are more likely to provide better experiences based on past interactions with the system.

In some embodiments, the system provides a means for earning money for performing a service without the need to be operating in a brick-and-mortar business. This provides a higher earning potential for the service provider by removing the need to pay rent or fees for using the business facilities.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A system for requesting and providing an in-home service, the system comprising:
a requester device to permit a requester to transmit a request for an in-home service to a provider device via a network;
a service database to store service information corresponding to a plurality of services; and
a provider database to store provider information corresponding to a plurality of providers, wherein a search engine is operable to permit the request to search the provider information and select the in-home service via a user interface module.

2. The system of claim 1, further comprising a scheduling system to provide a means for scheduling the in-home service via the requester device.

3. The system of claim 2, further comprising a GPS system to provide a location for the requester and the provider, wherein the provider may input a maximum distance from the requester.

4. The system of claim 3, further comprising a communications engine to permit communications between the requester and the provider.

5. The system of claim 4, further comprising a payment processing engine to permit the transmission of money between the requester and the provider.

6. The system of claim 5, wherein the service information comprises the following: service type, provider gender, service cost, length of service, and location of service.
